(19) United States
(12) Patent Application Publication
(10) Pub. No.: US 2026/0214312 A1
(43) Pub. Date: Jul. 23, 2026

(54) CAMERA DEVICE

(71) Applicant: Chicony Electronics Co., Ltd., New Taipei City (TW)

(72) Inventors: Li-Hsing Tsai, New Taipei City (TW); Jin-Kae Jang, New Taipei City (TW)

(21) Appl. No.: 19/210,566

(22) Filed: May 16, 2025

(30) Foreign Application Priority Data
Jan. 21, 2025 (TW) 114102616

(51) Int. Cl. H04N 23/55; H04N 23/54

(52) U.S. Cl. CPC H04N 23/55; H04N 23/54

(57) ABSTRACT

A camera device includes a circuit board, a fixed adhesive layer, a spacer, and a lens module. The circuit board has an assembling surface and a photosensitive element, the fixed adhesive layer is disposed on the assembling surface of the circuit board, and the fixed adhesive layer is spaced apart from the photosensitive element. The spacer is attached to the fixed adhesive layer. The lens module is detachably assembled on the spacer, so that the lens module does not contact the fixed adhesive layer.

### CROSS-REFERENCE TO RELATED APPLICATION

This non-provisional application claims priority under 35 U.S.C. § 119(a) to Patent Application No. 114102616 filed in Taiwan, R.O.C. on Jan. 21, 2025, the entire contents of which are hereby incorporated by reference.

### BACKGROUND

### Technical Field

The instant disclosure relates to an optical device, in particular, to a camera device.

### Related Art

Along with developments of technology, camera devices are widely used in different fields, such as personal electronic products, automobiles, and medical sciences for capturing external images.

### SUMMARY

In general, a camera device known to the inventor includes a lens module and a circuit board, and the lens module is fixed on the circuit board through an adhesive layer. However, when the lens module has defective conditions or is malfunctioned and thus needs to be repaired or adjusted, the repair personnel need to remove the adhesive before conducting the repair procedure. Because the lens module and the adhesive layer are directly adhered with each other, during the process of removing the adhesive layer, the lens module may be damaged easily. As a result, the lens module cannot be used anymore and needs to be scrapped eventually.

In view of this, in one embodiment, a camera device is provided. The camera device comprises a circuit board, a fixed adhesive layer, a spacer, and a lens module. The circuit board has an assembling surface and a photosensitive element, the fixed adhesive layer is disposed on the assembling surface of the circuit board, and the fixed adhesive layer is spaced apart from the photosensitive element. The spacer is attached to the fixed adhesive layer. The lens module is detachably assembled on the spacer, so that the lens module does not contact the fixed adhesive layer.

As above, according to the camera device of one or some embodiments of the instant disclosure, the spacer is blocked between the lens module and the fixed adhesive layer, and the lens module is detachably assembled on the spacer. Therefore, when the lens module has defective conditions during production, test, or use, the lens module can be detached from the spacer easily for subsequent repairs or adjustment procedures. Therefore, the lens module does not need to be replaced with a new one, and thus the scrap rate and the production cost can be effectively reduced.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a camera device according to an exemplary embodiment of the instant disclosure;

FIG. 2 illustrates an exploded view of the camera device of the exemplary embodiment;

FIG. 3 illustrates a schematic disassembled view of the lens module of the camera device of the exemplary embodiment;

FIG. 4 illustrates an exploded view of a camera device according to another embodiment of the instant disclosure;

FIG. 5 illustrates an exploded partial view of the camera device of the exemplary embodiment;

FIG. 6 illustrates a cross-sectional view along line 6-6 shown in FIG. 1;

FIG. 7 illustrates an enlarged partial view of FIG. 6; and

FIG. 8 illustrates a partial cross-sectional view of the camera device of one another embodiment.

### DETAILED DESCRIPTION

It should be noted that, in the descriptions for the embodiments, the ordinal numbers, e.g., “first” and “second” are respectively used to describe different elements, and these elements are not limited due to the use of these ordinal numbers. Furthermore, for the sake of convenience and clarity, the thickness or size of each component in the drawings is exaggerated, omitted, or schematically expressed for the purpose of understanding and reading by persons having ordinary skills in the art, and the size of each component is not the actual size of the component and is not intended to limit the conditions under which the instant disclosure can be implemented, and thus the size of the component does not have substantive technical meaning. Moreover, it is understood that, any structural modifications, changes in proportions, or adjustments in size should still fall within the scope of the technical content disclosed in the instant disclosure without affecting the effects that can be produced and the purposes that can be achieved by the instant disclosure. Moreover, in all the drawings, the same reference numbers are used to indicate identical or similar elements.

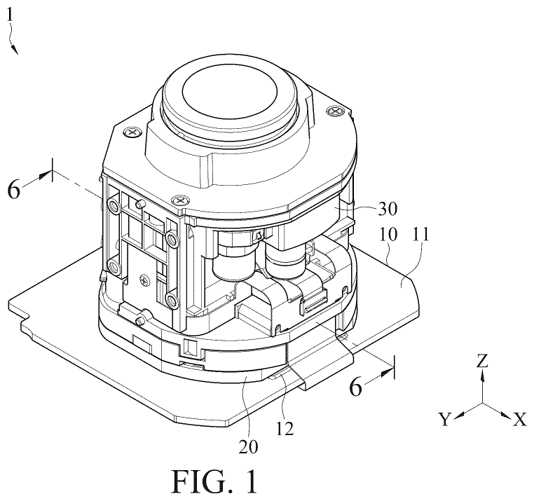

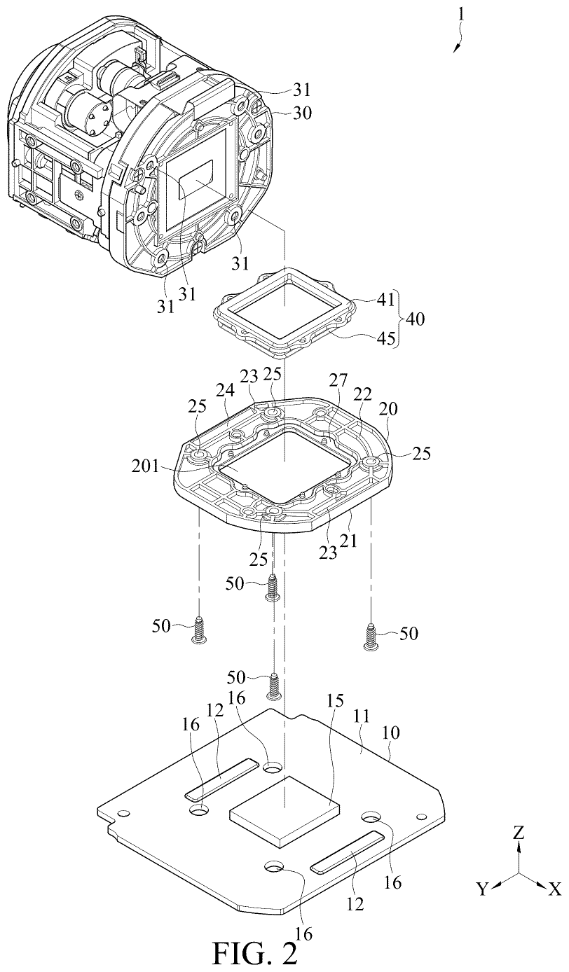

FIG. 1 illustrates a perspective view of a camera device according to an exemplary embodiment of the instant disclosure. FIG. 2 illustrates an exploded view of the camera device of the exemplary embodiment. As shown in FIG. 1 and FIG. 2, in this embodiment, the camera device 1 comprises a circuit board 10, a fixed adhesive layer 12, a spacer 20, a lens module 30, and a seal ring 40. In some embodiments, the camera device 1 may be utilized in different electronic devices for capturing images around the electronic devices. For example, the camera device 1 may be utilized in automotive products (e.g., dash cams, backup camera systems, or surrounding view systems), mobile devices (e.g., smart phones, tablet computers, or notebook computers), cameras, or other electronic devices.

As shown in FIG. 1 and FIG. 2, the circuit board 10 has an assembling surface 11 and a photosensitive element 15. In this embodiment, the photosensitive element 15 is disposed on the assembling surface 11 of the circuit board 10. For example, the photosensitive element 15 may be fixed on the assembling surface 11 through adhering, engaging, locking, or other manners, but the instant disclosure is not limited thereto. In some embodiments, the photosensitive element 15 may be disposed inside the hole of the circuit board 10.

In some embodiments, the photosensitive element 15 may be a charge-coupled device (CCD), a complementary metal-oxide semiconductor (CMOS), or a CMOS active pixel sensor for sensing and obtaining the images.

As shown in FIG. 1 and FIG. 2, the fixed adhesive layer 12 is disposed on the assembling surface 11 of the circuit board 10, and the fixed adhesive layer 12 is spaced apart from the photosensitive element 15. Moreover, the number of the fixed adhesive layer 12 may be one or more, and the shape of the fixed adhesive layer 12 is not limited. For example, in this embodiment, the fixed adhesive layer 12 is bar-shaped and the number of the fixed adhesive layer 12 is two. The two fixed adhesive layers 12 are respectively at two opposite sides of the photosensitive element 15 and adhered to regions of the assembling surface 11 of the circuit board 10. In some embodiments, the number of the fixed adhesive layer 12 may be one. For example, the fixed adhesive layer 12 is an annular adhesive layer and surrounds the periphery of the photosensitive element 15.

As shown in FIG. 1 and FIG. 2, the spacer 20 is disposed on the assembling surface 11 of the circuit board 10. The spacer 20 may be a plate or a sheet, and the spacer 20 may be integrally formed as a one-piece structure or formed by assembling several plates or sheets with each other. In this embodiment, the spacer 20 has a first surface 21 and a second surface 22 opposite to the first surface 21, where the first surface 21 faces the circuit board 10, and the second surface 22 faces the lens module 30. The first surface 21 of the spacer 20 is attached to the fixed adhesive layer 12, so that the spacer 20 is fixed on the assembling surface 11 of the circuit board 10 through the fixed adhesive layer 12. Moreover, in this embodiment, the number of the fixed adhesive layer 12 is two, and the two fixed adhesive layers 12 are respectively adhered to regions of the first surface 21 of the spacer 20 (in this embodiment, the two fixed adhesive layers 12 are respectively adhered to the two opposite sides of the first surface 21), but the instant disclosure is not limited thereto.

As shown in FIG. 1 and FIG. 2, in this embodiment, the spacer 20 is annular and has a central through hole 201. When the spacer 20 is assembled on the assembling surface 11 of the circuit board 10, the position of the photosensitive element 15 may correspond to the position of the central through hole 201. Alternatively, in some embodiments, the photosensitive element 15 may be inside the central through hole 201, so that the photosensitive element 15 is not shielded by the spacer 15 and thus is capable of receiving external light.

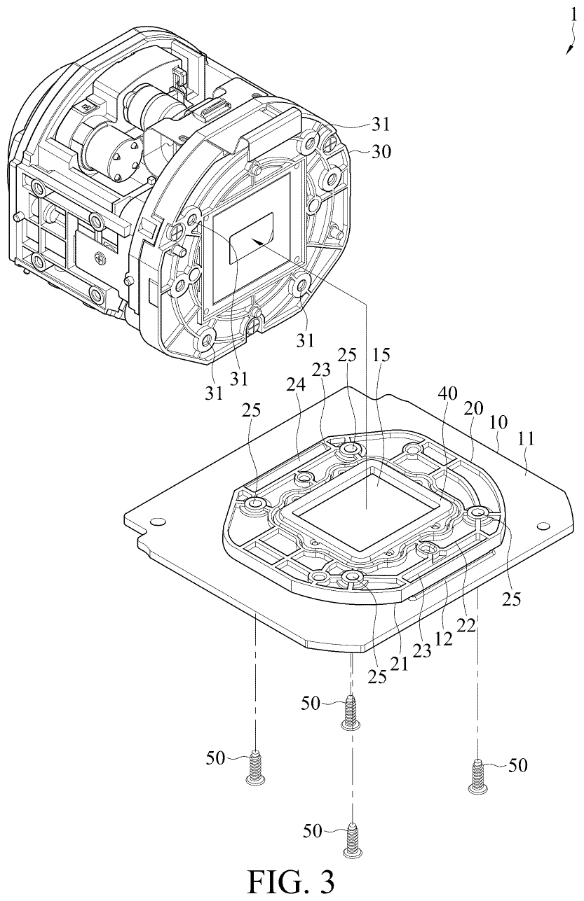

FIG. 3 illustrates a schematic disassembled view of the lens module of the camera device of the exemplary embodiment. As shown in FIG. 1 to FIG. 3, the lens module 30 is disposed on the spacer 20, and the lens module 30 is covered on the photosensitive element 15. The lens module 30 may comprise at least one lens (not shown), and the lens is provided for focusing external light, so that the external light can be transmitted to the photosensitive element 15 through the lens module 30, thereby allowing the photosensitive element 15 to sense and obtain images. In this embodiment, the lens module 30 is detachably assembled on the spacer 20, so that the lens module 30 does not directly contact the fixed adhesive layer 12. In other words, in this embodiment, the spacer 20 is not a part of the lens module 30, and the spacer 20 is an individual component for separating the lens module 30 from the fixed adhesive layer(s) 12, so that the lens module 30 can be detached from the spacer 20 freely.

Accordingly, as shown in FIG. 2 and FIG. 3, in this embodiment, the spacer 20 is between the lens module 30 and the fixed adhesive layer 12, and the lens module 30 is detachably assembled on the spacer 20. Therefore, when the lens module 30 has defective conditions during production, test, or use, the lens module 30 can be detached from the spacer 20 easily for subsequent repair or adjustment procedures. Therefore, the lens module 30 does not need to be replaced with a new one (it is understood that the unit price of the lens module 30 is higher as compared with other components), and thus the scrap rate, the used amount of materials, and the production cost can be effectively reduced.

In some embodiments, the lens module 30 and the spacer 20 may be assembled with each other through engaging, locking, threading, or other manners. Therefore, the lens module 30 does not be damaged during detaching the lens module 30 from the spacer 20. In some embodiments, the spacer 20 has one or more first assembling portions 25. As shown in FIG. 2 and FIG. 3, in this embodiment, the number of the first assembling portion 25 is four, and the four first assembling portions 25 are respectively adjacent to four corners of the spacer 20. One side of the lens module 30 facing the circuit board 10 has a second assembling portion 31, and the number and the position of the second assembling portion 31 correspond to the number and the position of the first assembling portion 25 of the spacer 20. Each of the first assembling portions 25 of the spacer 20 can be assembled with a corresponding one of the second assembling portions 31 of the lens module 30. The circuit board 10 has a hollow portion 16, and the number and the position of the hollow portion 16 correspond to the number and the position of the first assembling portion 25. Therefore, when the lens module 30 is to be detached from the spacer 20, the operator can conduct the detachment procedure through the hollow portion 16 easily. For example, the operator can insert the tool into the hollow portion 16, so that the tool can detach the first assembling portions 25 of the spacer 20 from the second assembling portions 31 of the lens module 30.

As shown in FIG. 2 and FIG. 3, in this embodiment, both the first assembling portions 25 of the spacer 20 and the second assembling portions 31 of the lens module 30 are holes, and a fixing member 50 is assembled in each of the first assembling portions 25 and the corresponding one of the second assembling portions 31. For example, the fixing member 50 may be a rivet, a screw, a bolt, or the like, so that the spacer 30 and the lens module 30 can be assembled with each other while the lens module 30 still can be detached from the spacer 20 without being damaged.

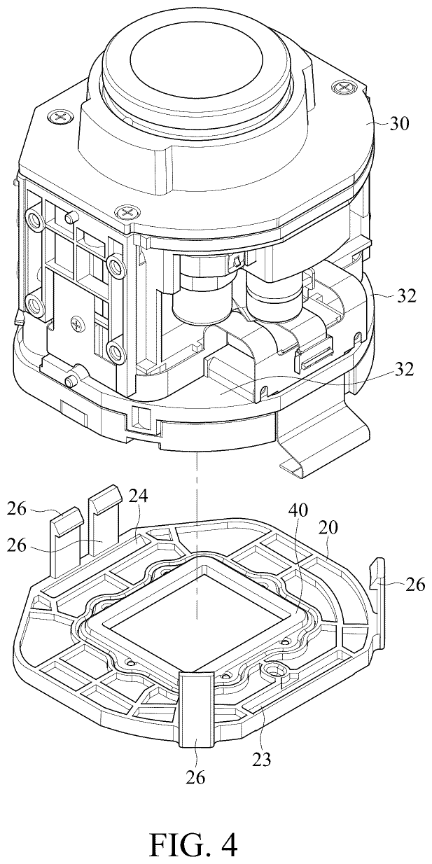

FIG. 4 illustrates an exploded view of a camera device according to another embodiment of the instant disclosure. As shown in FIG. 4, the assembling structures of the spacer 20 and the lens module 30 may be at the outer peripheries of the spacer 20 and the lens module 30. Therefore, when the lens module 30 is to be detached from the spacer 20, the operator can conduct the detach procedure from the periphery of the camera device 1, and the circuit board 10 thus does not necessarily need to be provided with the hollow portion 16. For example, in some embodiments, the outer periphery of the spacer 20 has one or more first assembling members 26. In this embodiment, the number of the first assembling member 26 is four, and the four first assembling members 26 are arranged and spaced apart from each other. The outer periphery of the lens module 30 has a second assembling member 32, the number and the position of the second assembling member 32 correspond to the number and the position of the first assembling member 26, and each of the first assembling members 26 of the spacer 20 can be assembled with a corresponding one of the second assembling members 32 of the lens module 30.

As shown in FIG. 4, in this embodiment, each of the first assembling members 26 of the spacer 20 is an engaging member, and each of the first assembling members 26 is integrally connected to the outer periphery of the spacer 20. Each of the second assembling members 32 of the lens module 30 is an engaging groove. Each of the first assembling members 26 can be detachably engaged with the corresponding one of the second assembling members 32, so that the spacer 20 and the lens module 30 can be assembled with each other, while the lens module 30 can still be detached from the spacer 20 without being damaged. However, the embodiments are provided for illustrative purposes, and the instant disclosure is not limited thereto. In some other embodiments, the first assembling members 26 and the second assembling members 32 may be different assembling structures, or structures of the first assembling members 26 and the second assembling members 32 may be exchanged.

As shown in FIG. 2 and FIG. 3, the fixed adhesive layer 12 on the assembling surface 11 of the circuit board 10 may be a light curing adhesive layer (for example, a UV light curing adhesive layer). Therefore, during the assembling process of the camera device 1, the focal length of the lens module 30 can be adjusted through the fixed adhesive layer 12. For example, before the fixed adhesive layer 12 is illuminated by the light (such as the UV light), the fixed adhesive layer 12 is in an uncured state. Therefore, during the assembling process of the camera device 1, the lens module 30 and the spacer 20 are assembled with each other, and the spacer 20 is then placed on the fixed adhesive layer 12 which is in the uncured state. Hence, the spacer 20 can be moved with respect to the circuit board 10 to have lifting, shifting, pitching, or yawing movements, and thus the relative position between the lens module 30 and the photosensitive element 15 can be adjusted to conduct the focus procedure. Next, after the central axis of the lens module 30 is overlapped with the central axis of the photosensitive element 15 and the image sensed by the photosensitive element 15 is adjusted to be clear, the fixed adhesive layer 12 can be illuminated by the light to allow the fixed adhesive layer 12 to be in the cured state. Therefore, the spacer 20 can be fixed on the assembling surface 11 of the circuit board 10, so that the relative positions between the lens module 30 and the photosensitive element 15 can be fixed. However, the embodiments are provided for illustrative purposes, and the instant disclosure is not limited thereto. In some other embodiments, the fixed adhesive layers 12 may be other types of adhesive layers. Moreover, after the spacer 20 is moved with respect to the circuit board 10 to allow the lens module 30 to be in the focused position, the spacer 20 and the circuit board 10 may be not aligned parallel to each other, while the instant disclosure is not limited thereto.

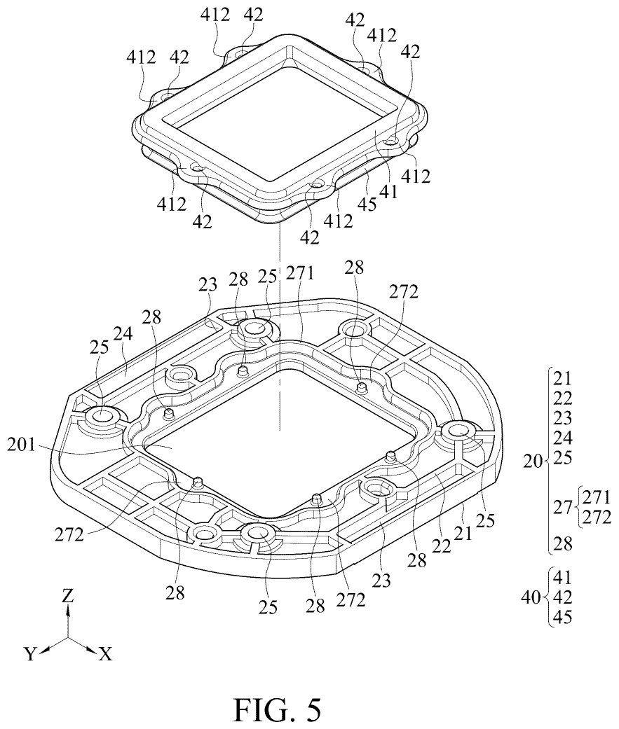

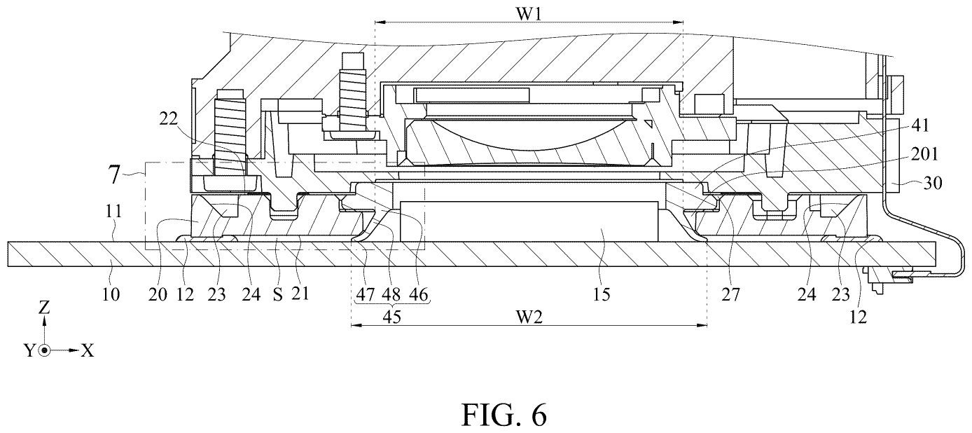

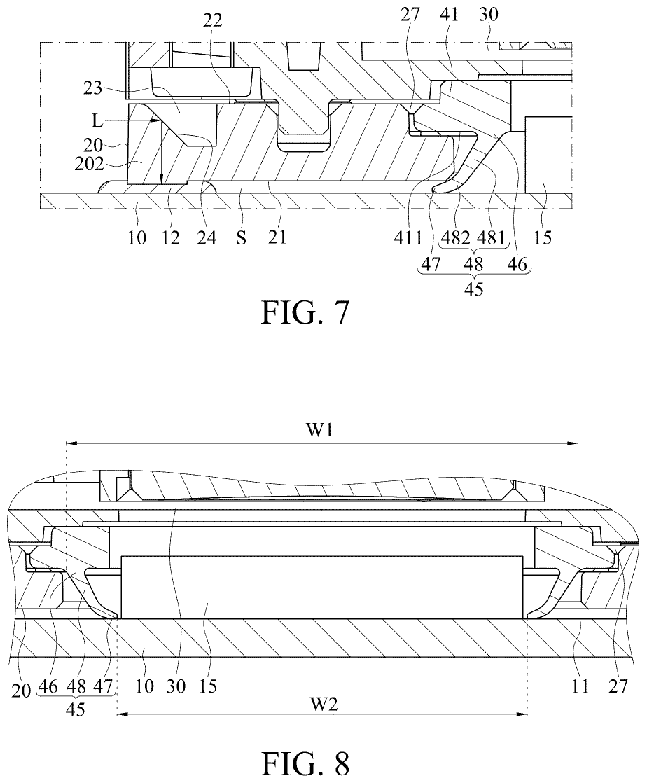

FIG. 5 illustrates an exploded partial view of the camera device of the exemplary embodiment. FIG. 6 illustrates a cross-sectional view along line 6-6 shown in FIG. 1. FIG. 7 illustrates an enlarged partial view of FIG. 6. As shown in FIG. 2, FIG. 3, and FIG. 5 to FIG. 7, in the case that the fixed adhesive layer 12 on the assembling surface 11 of the circuit board 10 is a light curing adhesive layer, the spacer 20 may be a light-transmissive spacer. For example, the entirety of the spacer 20 may be transparent or semi-transparent. Alternatively, in some embodiments, a region of the spacer 20 may have a light-transmissive portion 202, and the position of the light-transmissive portion 202 corresponds to the position of the fixed adhesive layer 12 (for example, as shown in FIG. 7). Accordingly, as mentioned above, during the process of illuminating the light on the fixed adhesive layer 12 of the camera device 1, the light can pass through the spacer 20 or the light-transmissive portion 202 and is not blocked by the spacer 20, so that the fixed adhesive layer 12 can be cured by the light more easily.

Further, as shown in FIG. 6 and FIG. 7, one or more light guiding bevels 24 may be between the first surface 21 and the second surface 22 of the spacer 20 for guiding the light, and the number and the position of the light guiding bevel 24 may correspond to the number and the position of the fixed adhesive layer 12. For example, in this embodiment, the number of the light-guiding bevel 24 is two, and the two light-guiding bevels 24 are respectively adjacent to two opposite sides of the spacer 20 to correspond to the two fixed adhesive layers 12. An included angle is between each of the light-guiding bevels 24 and the assembling surface 11 of the circuit board 10 (for example, the included angle may be an acute angle or an obtuse angle). Therefore, when the light L enters the spacer 20 from two sides of the spacer 20, the light-guiding bevel 24 can guide the light L to be collectively illuminated on the fixed adhesive layer 12, thereby ensuring proper light illumination on the fixed adhesive layer 12. Furthermore, in this embodiment, the second surface 22 of the spacer 20 has two recessed grooves 23, the two recessed grooves 23 are respectively adjacent to the two opposite sides of the spacer 20, and the two light-guiding bevels 24 are respectively in the two recessed grooves 23, but the instant disclosure is not limited thereto.

As shown in FIG. 2 and FIG. 5 to FIG. 7, the spacer 20 may be an annular spacer and has an annular groove 27, and the annular groove 27 is provided for being assembled with the seal ring 40. In this embodiment, the annular groove 27 is recessed from the second surface 22 of the spacer 20, the annular groove 27 surrounds the periphery of the central through hole 201, and the annular groove 27 is in communication with the central through hole 201. The shape of the annular groove 27 corresponds to the shape of the seal ring 40. For example, the annular groove 27 and the seal ring 40 may be rectangular (as shown in FIG. 5), round, elliptical, square, or other irregular shapes, and the instant disclosure is not limited thereto.

As shown in FIG. 2 and FIG. 5 to FIG. 7, the seal ring 40 comprises an annular body 41 and an elastic ring 45. The seal ring 40 may be made of an opaque material to block external light from entering the space formed by the lens module 30, the spacer 20, the seal ring 40 and the circuit board 10, the opaque material may be rubber, plastic, or a composite material (such as a composite material of rubber and plastic or a composite material of rubber and metal), and the seal ring 40 has good corrosion resistance, high temperature resistance, elasticity, and flexibility. The annular body 41 is disposed in the annular groove 27 of the spacer 20. For example, the annular body 41 may be fixed in the annular groove 27 through engaging, locking, adhering, or other manners, and the annular body 41 has an inner surface 411 facing the assembling surface 11 of the circuit board 10. The elastic ring 45 is inserted into the central through hole 201 of the spacer 20 and surrounds the periphery of the photosensitive element 15. The elastic ring 45 has a root portion 46, an end portion 47, and a flexible blocking wall 48, where the root portion 46 is opposite to the end portion 47. The root portion 46, the end portion 47, and the flexible blocking wall 48 are all formed as annular structures, and the flexible blocking wall 48 is integrally connected between the root portion 46 and the end portion 47. The elastic ring 45 may be integrally connected to the inner surface 411 of the annular body 41 or assembled with the inner surface 411 of the annular body 41. For example, in this embodiment, the root portion 46 of the elastic ring 45 is integrally connected to the inner surface 411 of the annular body 41 to form a one-piece structure with the annular body 41, and the flexible blocking wall 48 of the elastic ring 45 is not perpendicular to the assembling surface 11 of the circuit board 10. That is, in this embodiment, an included angle may be between the flexible blocking wall 48 of the elastic ring 45 and the assembling surface 11 of the circuit board 10 (as shown in FIG. 6 and FIG. 7, the included angle may be an acute angle or an obtuse angle), and the end portion 47 of the elastic ring 45 contacts the assembling surface 11 of the circuit board 10.

Accordingly, as shown in FIG. 2 and FIG. 5 to FIG. 7, in this embodiment, the elastic ring 45 of the seal ring 40 surrounds the periphery of the photosensitive element 15, and the end portion 47 of the elastic ring 45 contacts the assembling surface 11 of the circuit board 10. Therefore, external light, dust, or objects can be prevented from entering the interior of the camera device 1 to affect the image quality of the photosensitive element 15. Moreover, the flexible blocking wall 48 of the elastic ring 45 is not perpendicular to the assembling surface 11 of the circuit board 10, therefore after the assembling of the elastic ring 45 is completed, the elastic ring 45 does not provide an excessive pressure on the circuit board 10 or the lens module 30 which will thus cause deformation or displacement of the circuit board 10 or the lens module 30. Hence, the images captured by the camera device 1 can have a good quality.

Moreover, specifically, as shown in FIG. 2 and FIG. 5 to FIG. 7, in this embodiment, the camera device 1 has an axial direction (the Z-axis direction shown in FIG. 2, FIG. 5, and FIG. 6) and a vertical direction (the X-axis direction shown in FIG. 2, FIG. 5, and FIG. 6), where the axial direction is perpendicular to the assembling surface 11 of the circuit board 10, and the vertical direction is perpendicular to the axial direction. After the assembling of the camera device 1 is completed, the lens module 30 abuts against the seal ring 40, so that the end portion 47 of the elastic ring 45 of the seal ring 40 abuts against the assembling surface 11 of the circuit board 10 to have interference fit with the assembling surface 11, thereby preventing external light and dust from entering the space formed by the lens module 30, the spacer 20, the seal ring 40 and the circuit board 10. Therefore, if the elastic ring 45 is perpendicular to the assembling surface 11 of the circuit board 10, the elastic ring 45 produces a pressure on the circuit board 10 and the lens module 30 along the axial direction (the Z-axis direction shown in FIG. 2, FIG. 5, and FIG. 6), which will thus cause deformation or displacement of the circuit board 10 or the lens module 30 to affect the image quality of the photosensitive element 15.

Based on the above, according to one or some embodiments of the instant disclosure, the flexible blocking wall 48 of the elastic ring 45 is not perpendicular to the assembling surface 11 of the circuit board 10. Therefore, when the end portion 47 of the elastic ring 45 of the seal ring 40 abuts against the assembling surface 11 of the circuit board 10, the end portion 47 of the elastic ring 45 and the flexible blocking wall 48 can be bent and deformed. For example, as shown in FIG. 6 and FIG. 7, when the end portion 47 of the elastic ring 45 abuts against the assembling surface 11, the flexible blocking wall 48 is subjected to a force to be bent and thus to form an extension section 481 and a bent section 482, where the extension section 481 is connected to the root portion 46, and the bent section 482 is connected between the extension section 481 and the end portion 47. Therefore, the pressure of the seal ring 40 on the circuit board 10 and the lens module 30 along the axial direction (the Z-axis direction shown in FIG. 2, FIG. 5, and FIG. 6) can be greatly reduced, thereby preventing deformation or displacement of the circuit board 10 or the lens module 30 upon the circuit board 10 or the lens module 30 is subjected to a force.

As shown in FIG. 2 and FIG. 5 to FIG. 7, in this embodiment, the thickness of the elastic ring 45 of the seal ring 40 along the vertical direction (the X-axis direction shown in FIG. 2, FIG. 5, and FIG. 6) may be less than the thickness of the annular body 41 along the vertical direction. Therefore, the rigidity of the elastic ring 45 is less than the rigidity of the annular body 41 and thus the elastic ring 45 will be deformed more easily upon being subjected to a force. Hence, when the end portion 47 of the elastic ring 45 of the seal ring 40 abuts against the assembling surface 11 of the circuit board 10, the pressure of the seal ring 40 on the circuit board 10 and the lens module 30 along the axial direction (the Z-axis direction shown in FIG. 2, FIG. 5, and FIG. 6) can be further reduced.

As shown in FIG. 2 and FIG. 5 to FIG. 7, the thickness of the root portion 46 and the end portion 47 of the elastic ring 45 of the seal ring 40 may be different from each other. For example, in this embodiment, the thickness of the end portion 47 of the elastic ring 45 along the vertical direction (the X-axis direction shown in FIG. 2, FIG. 5, and FIG. 6) is less than the thickness of the root portion 46 along the vertical direction. Therefore, the rigidity of the end portion 47 of the elastic ring 45 and the rigidity of the portion of the flexible blocking wall 48 adjacent to the end portion 47 may be further reduced. Therefore, when the end portion 47 of the elastic ring 45 of the seal ring 40 abuts against the assembling surface 11 of the circuit board 10, the pressure of the seal ring 40 on the circuit board 10 and the lens module 30 along the axial direction (the Z-axis direction shown in FIG. 2, FIG. 5, and FIG. 6) can be further reduced.

In some embodiments, the sizes of the root portion 46 and the end portion 47 of the elastic ring 45 of the seal ring 40 may be different from each other. As shown in FIG. 2 and FIG. 6, in this embodiment, the root portion 46 and the end portion 47 of the elastic ring 45 of the seal ring 40 are respectively formed as rectangular ring structures, and the side length W1 of the root portion 46 along the vertical direction (the X-axis direction shown in FIG. 2, FIG. 5, and FIG. 6) is less than the side length W2 of the end portion 47 along the vertical direction, so that the elastic ring 45 is not perpendicular to the assembling surface 11 of the circuit board 10, and the root portion 46 is nearer to the photosensitive element 15 as compared with the end portion 47 (that is, in this embodiment, the distance between the root portion 46 and the photosensitive element 15 is less than the distance between the end portion 47 and the photosensitive element 15). Alternatively, as shown in FIG. 8, FIG. 8 illustrates a partial cross-sectional view of a camera device according to another embodiment of the instant disclosure. In another embodiment, the side length W1 of the root portion 46 of the elastic ring 45 of the seal ring 40 along the vertical direction (the X-axis direction shown in FIG. 2, FIG. 5, and FIG. 6) may be greater than the side length W2 of the end portion 47 along the vertical direction, so that the end portion 47 is nearer to the photosensitive element 15 as compared with the root portion 46 (that is, in this embodiment, the distance between the end portion 47 and the photosensitive element 15 is less than the distance between the root portion 46 and the photosensitive element 15). However, the embodiments are provided for illustrative purposes, and the instant disclosure is not limited thereto. In some other embodiments, in the case that both the root portion 46 and the end portion 47 of the elastic ring 45 are formed as circular ring structures, the diameter of the root portion 46 may be different from the diameter of the end portion 47, so that the elastic ring 45 is not perpendicular to the assembling surface 11 of the circuit board 10.

Moreover, as shown in FIG. 6 and FIG. 7, in this embodiment, because the spacer 20 is attached to the fixed adhesive layer 12 on the assembling surface 11 of the circuit board 10, a separation space S is between the spacer 20 and the assembling surface 11, and the end portion 47 of the elastic ring 45 of the seal ring 40 may be further inserted into the separation space S to further preventing external light and dust from entering the space formed by the lens module 30, the spacer 20, the seal ring 40 and the circuit board 10.

As shown in FIG. 2 and FIG. 5, one or more first limiting members 28 may be in the annular groove 27 of the spacer 20. In this embodiment, the number of the first limiting member 28 is plural and the first limiting members 28 are arranged spaced apart from each other. The annular body 41 of the seal ring 40 has one or more second limiting members 42, the number and the position of the second limiting members 42 correspond to the number and the position of the first limiting members 28, and each of the second limiting members 42 is assembled with a corresponding one of the first limiting members 28 to enhance the robustness of the seal ring 40. In this embodiment, the first limiting member 28 in the annular groove 27 may be a protruding post, the second limiting member of the annular body 41 may be a through hole, and each of the first limiting members 28 is inserted into the corresponding one of the second limiting members 42 to position the seal ring 40 in the annular groove 27. However, the embodiments are provided for illustrative purposes, and the instant disclosure is not limited thereto. In some other embodiments, the first limiting members 28 and the second limiting members 42 may be different assembling structures, or structures of the first limiting members 28 and the second limiting members 42 may be exchanged.

Further, in some embodiments, the annular groove 27 of the spacer 20 has an annular side wall 271, and the annular side wall 271 has one or more side grooves 272. As shown in FIG. 2 and FIG. 5, in this embodiment, the number of the side groove 272 is plural, and the side grooves 272 are arranged spaced apart from each other. The periphery of the annular body 41 of the seal ring 40 has one or more protrusions 412, the number and the position of the protrusion 412 correspond to the number and the position of the side groove 272, and each of the protrusions 412 is limited within a corresponding one of the side grooves 272 to further enhance the positioning performance of the seal ring 40. Moreover, in this embodiment, each of the second limiting members 42 of the annular body 41 is on a corresponding one of the protrusions 412, but the instant disclosure is not limited thereto.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A camera device comprising:
a circuit board having an assembling surface and a photosensitive element;
a fixed adhesive layer disposed on the assembling surface of the circuit board, wherein the fixed adhesive layer is spaced apart from the photosensitive element;
a spacer attached to the fixed adhesive layer; and
a lens module detachably assembled on the spacer, so that the lens module does not contact the fixed adhesive layer.

2. The camera device according to claim 1, wherein the fixed adhesive layer is a light curing adhesive layer.

3. The camera device according to claim 2, wherein the spacer is a light-transmissive spacer.

4. The camera device according to claim 2, wherein the spacer has a light-transmissive portion, and a position of the light-transmissive portion corresponds to a position of the fixed adhesive layer.

5. The camera device according to claim 1, wherein the spacer has a first surface and a second surface opposite to each other, the fixed adhesive layer is attached to a region of the first surface, a light-guiding bevel is between the first surface and the second surface, and a position of the light-guiding bevel corresponds to a position of the fixed adhesive layer.

6. The camera device according to claim 5, wherein the second surface has an recessed groove, and the light-guiding bevel is in the recessed groove.

7. The camera device according to claim 1, wherein the spacer has a first assembling portion, one side of the lens module facing the circuit board has a second assembling portion, the first assembling portion is detachably assembled with the second assembling portion, the circuit board has a hollow portion, and a position of the hollow portion corresponds to a position of the first assembling portion of the spacer.

8. The camera device according to claim 7, wherein the first assembling portion and the second assembling portion are holes, and a fixing member is assembled in the first assembling portion and the second assembling portion.

9. The camera device according to claim 1, wherein an outer periphery of the spacer has a first assembling member, an outer periphery of the lens module has a second assembling member, and the second assembling member is detachably assembled with the first assembling member.

10. The camera device according to claim 9, wherein the first assembling member is an engaging member, the second assembling member is an engaging groove, and the engaging member is detachably engaged with the engaging groove.

11. The camera device according to claim 1, wherein the spacer is an annular spacer and has an annular groove, and a seal ring is in the annular groove.
